(19) United States
(12) Patent Application Publication
(10) Pub. No.: US 2014/0212213 A1
(43) Pub. Date: Jul. 31, 2014

(54) COMPRESSION SLEEVES

(71) Applicants: Richard G. Meyers, Euclid, OH (US); Raymond Disantis, Willoughby Hills, OH (US)

(72) Inventors: Richard G. Meyers, Euclid, OH (US); Raymond Disantis, Willoughby Hills, OH (US)

(73) Assignee: The National Telephone Supply Company, Cleveland, OH (US)

(21) Appl. No.: 14/143,466

(22) Filed: Dec. 30, 2013

Related U.S. Application Data
(60) Provisional application No. 61/746,871, filed on Dec. 28, 2012.

(51) Int. Cl. F16B 7/04

(52) U.S. Cl. CPC F16B 7/0433
USPC 403/396

(57) ABSTRACT

A compression sleeve for connecting and swaging cable has an outer housing having one or more passages therethrough for holding a cable having a sheath thereon. The passages have a series of teeth separated by blunt roots which extrudes and removes the sheath from the cable thereby swaging the sleeve to a metal portion of the cable. The sleeve can be pressed at a first central position such that the teeth engage the sheath of the cable. The sleeve can also be pressed at subsequent positions extending outwardly from the central position of the sleeve such that the teeth engage the sheath of the cable.

### CLAIM OF PRIORITY

This application claims priority from Provisional Patent Application Ser. No. 61/746,871, filed on Dec. 28, 2012, which is hereby incorporated by reference in its entirety.

### BACKGROUND OF THE DISCLOSURE

The disclosure pertains to mechanical/electrical connectors for wire, wire rope, synthetic cable or cable conductors. More specifically, the disclosure relates to compression-type mechanical/electrical sleeves or connectors for connecting a first cable to a second cable and for removing sheath from cable while swaging a sleeve to the cable.

The present disclosure provides sleeves or connectors which are specifically configured to accept a range of cable sizes, which provides cable receiving cavities characterized by gripping means capable of deforming to vary the size of the cavities.

Referring now to FIG. 1, existing oval and FIG. 8 compression sleeves 10 are often used to terminate bare aircraft cables or wire rope 12 in an eye splice conformation 14. Referring to FIG. 2, existing oval and FIG. 8 compression sleeves 10 are often also used to connect bare aircraft cables and wire rope 12 in a lap or overlap splice conformation 16.

For various reasons the metal cable 12 is sometimes coated with plastic insulating sheath 20 typically fabricated of vinyl or Nylon. (see FIG. 3). Since compression sleeves do not grip plastic in a permanent manner (due to plastic creep/flow) it is necessary to remove the sheath for the length of the cable that passes thru the sleeve(s) such as to form an eye splice 14 or lap splice 16. (see FIGS. 4 and 5).

The existing methods of removing the sheath 20 (e.g., such as by cutting, skiving, heating/melting/decomposing, dissolving, freezing/breaking, etc.) are all time consuming, expensive, inconvenient and/or expose the bare metal of the cable which is undesirable and can result in damage to the cable.

Thus, it is desirable to provide a sleeve connection which does not require removing the sheath by piercing the sheath while providing other benefits and more advantageous results.

Currently, there is no system in place to easily identify the sleeve to be used with a particular type of die for rope or cable. Thus, there is also a need for a method of marking sleeves to easily identify the type of cable the sleeve is being used with.

### SUMMARY OF THE DISCLOSURE

In accordance with one aspect of the disclosure, a compression sleeve for connecting cable and removing sheath from a cable includes an outer housing or body having a first passage therethrough for holding a cable having a sheath thereon. The first passage has a series of teeth separated by blunt roots which removes the sheath from the cable thereby swaging the sleeve to a metal portion of the cable.

In accordance with another aspect of the disclosure, a method of progressively pressing a sleeve to a cable, including the steps of: 1) providing a sleeve having a plurality of teeth extending into a passage formed in the sleeve; 2) extending a metal cable having a sheath thereon through the passage of a sleeve; 3) pressing the sleeve at a first central position; 4) pressing the sleeve at subsequent positions extending outwardly from the central position of the sleeve; and 5) extruding the cable's sheath from the cable and swaging the sleeve to the cable.

In accordance with another aspect of the disclosure, a method of roller crimping a sleeve for connecting a cable, includes the steps of: 1) extending a coated cable into one or more openings of a serrated sleeve; 2) providing a first roller and a second roller on opposed sides of the sleeve; and 3) rolling the first roller and the second roller in a first rolling direction thereby crimping the sleeve onto the coated cable. The rolling direction can be moving from the eye splice to the end of the sleeve or moving from the end of the sleeve to the eye splice.

In accordance with another aspect of the disclosure, a sleeve/connector has a series of blunt roots with sharp teeth formed between the roots which eliminates the need to remove the sheath by piercing the sheath, extruding most of the sheath from between sleeve and metal of the cable, swaging the sleeve to metal of the cable (i.e., metal to metal) and immobilizing any sheath remaining inside the sleeve by forming a sheath/grit matrix formed by a grit coating. The grit coating is applied over the roots and teeth. The grit coating is shown in the preferred embodiment; however the grit coating is not required for the sleeve/connector to perform its function. The sleeve is shown to be symmetrical having the appearance of a FIG. 8, where a landing or neck portion is formed between upper opening of upper portion and a lower opening is formed in lower portion.

Another aspect of the disclosure is an end of metal cable is inside the extruded sheath of the cable eliminating the danger of cable strand ends extending out of the sheath. That is, the cable end is completely enclosed within sheath.

Yet another aspect of the disclosure is any number of sleeves/connectors may be placed anywhere on an insulated cable or wire to connect, tie, hold and position another cable or wire alongside another cable or wire.

Still another aspect of the disclosure is that a progressive pressing technique can be used, starting at the center of the sleeve, which produces optimum results, that is, it enables the shortest initial sleeve length to hold the insulated cable in an eye splice until the cable breaks.

In accordance with still another aspect of the disclosure, a lap splice is used wherein two sleeves may be required to break cable or wire as is often the case with ordinary ovals and bare cable or wire. The spaces between sleeves should be at least a sleeve length. One sleeve should be completely pressed before starting to press the other. The spacing and pressing sequence enables relatively free extrusion of the sheath.

In accordance with another aspect of the disclosure, oval and FIG. 8 sleeves are sometimes used by electric utilities to lap splice conductors. The sleeves described herein (with or without adhesive and grit) may be used in this way on insulated conductors.

The terms “plastic insulated”, “insulated”, and “plastic coated” are interchangeable in this disclosure. The terms “cable or wire”, “cable”, and “wire” are interchangeable in this disclosure. The terms “compression sleeve”, “connector”, and “sleeve” are interchangeable in this disclosure.

A laminated tooth bore or insert in the sleeve can replace the homogeneous material used in the sleeves in this disclosure.

A hard grit can optionally be used to form a high viscosity matrix with any sheath remaining in the sleeve bore. A heavy (or thick) anodized or other hard brittle coating may replace the grit, but may “puff” when pressed.

The sleeves may be fabricated of several suitable metal materials, such as homogeneous soft (or annealed) copper and aluminum. Other materials with similar physical characteristics, either conductive or not conductive may be used. Non-homogeneous materials such as clad, laminated or insert type materials can also be used.

Aluminum or copper sleeves may be tin-plated to improve conduction between sleeve and cable or wire; as well as providing a relatively stable electro-chemical interface between various metals such as copper, aluminum, zinc, steel, stainless steel and the environment.

The cable coatings are typically made from vinyl or Nylon. The coating may be over outer strands only or may permeate the cable. The bond strength between cable metal and plastic coating varies from cable to cable. Wire conductors may have bonded insulating sheath or loose tubing as insulation.

Stop or terminating sleeves and butt splice sleeves and eye type dead-ends and offset sleeves can be used with insulated cable or wire as well.

A stop sleeve designed to hold the cable or wire until it breaks is often called a terminating sleeve and is typically one-half the length of a full tension butt splice sleeve.

Offset splicing sleeves and dead-ends can be thought of as stop or terminating sleeves sequentially joined by short offsets where each compression leg is typically one-half the length of the corresponding butt splice sleeve.

A “sharp tip” or “sharp tooth” is defined as when the tip or tooth radius <<tooth height (i.e., tip or tooth radius is much less than tooth height).

Any compression connector/sleeve utilizing a sharp tooth bore configuration can be thought of as a super insulation displacement connector by virtue of the high contact area between connector and wire.

Another aspect of the disclosure is that the sleeve/connector eliminates the need to remove the sheath by piercing the sheath, by extruding most of the sheath from between sleeve and conductor, swaging the sleeve to the conductor (metal to metal) and immobilizing any sheath remaining inside the sleeve by forming a sheath and grit matrix; thereby making the splice, mechanically and electrically comparable to the conductor.

Other aspects of the disclosure will become apparent upon a reading and understanding of the following detailed description.

### BRIEF DESCRIPTION OF DRAWINGS

FIG. 1 is a side elevational view of a prior art compression sleeve;

FIG. 2 is a side elevational view of a prior art pair of compression sleeves and rope;

FIG. 3 is a side elevational view in cross section of a rope and prior art compression sleeve;

FIG. 4 is a side elevational view of a prior art eye splice compression sleeve assembly;

FIG. 5 is a side elevational view of a prior art compression sleeve assembly;

FIG. 6 illustrates a cross-sectional perspective view of a sleeve/connector in accordance with one aspect of the disclosure;

FIG. 7 is a cross-sectional view of the sleeve/connector of FIG. 6;

FIG. 8 illustrates a perspective view of the connector of FIGS. 6 and 7 used with an eye splice;

FIG. 8A is an enlarged partial view of detail A of FIG. 8;

FIG. 9 illustrates a perspective view of several connectors used in series with wire rope;

FIG. 10 illustrates a perspective view of the sleeve/connector in accordance with another aspect of the disclosure;

FIG. 11 is a side elevational view of a FIG. 8 sleeve in accordance with another aspect of the disclosure;

FIG. 12 is a side elevational view of an oval shaped sleeve in accordance with another aspect of the disclosure;

FIG. 13 is a side elevational view in cross-section of a stop or terminating sleeve in accordance with another aspect of the disclosure;

FIG. 14 is a side elevational view of a sleeve with oval shaped quadrants and teeth in accordance with another aspect of the disclosure;

FIG. 15 is a side elevational view of a sleeve with flat sided oval quadrants and teeth in accordance with another aspect of the disclosure;

FIG. 16 is a side elevational view of a sleeve with teeth and flat sided quadrants in accordance with another aspect of the disclosure;

FIG. 17 is a side elevational view of a sleeve with oval shaped walls and teeth in accordance with another aspect of the disclosure;

FIG. 18 is a side elevational view in cross-section of a sleeve with oval shaped quadrants and teeth showing a cable therein in accordance with another aspect of the disclosure;

FIG. 19 is a side elevational view of a stop or terminating sleeve and rope in accordance with another aspect of the disclosure;

FIG. 20 is a side elevational view of a stop sleeve and rope with a sheath thereon in accordance with another aspect of the disclosure;

FIG. 21 is a side elevational view of a stop sleeve with a rope having a sheath extending through the sleeve in accordance with another aspect of the disclosure;

FIG. 22 is a side elevational view of a plurality of stop sleeves on a rope in accordance with another aspect of the disclosure;

FIG. 23 shows a perspective view of a progressive pressing technique for a FIG. 8 sleeve;

FIG. 24 shows a side elevational view of a progressive pressing technique for a stop sleeve;

FIG. 24A shows an end view of the sleeve of FIG. 24;

FIG. 25A is a side elevational view of a progressive pressing of a sleeve by dies in accordance with another aspect of the disclosure;

FIG. 25B is a cross-sectional view of the sleeve of FIG. 25A;

FIG. 26A is a side elevational view of a progressive overlapping dies and a sleeve in accordance with another aspect of the disclosure;

FIG. 26B is a cross-sectional view of the sleeve of FIG. 26A;

FIG. 27 is a side elevational view of a progressive press with punch press dies in accordance with another aspect of the disclosure;

FIG. 28 is a side elevational view of a progressive press with spring loaded dies in accordance with another aspect of the disclosure;

FIG. 29 is a side elevational view of a progressive press with cam driven dies in accordance with another aspect of the disclosure;

FIG. 30 is a side elevational view of V-shaped press dies and a sleeve in accordance with another aspect of the disclosure;

FIG. 31 is a side elevational view of the die of FIG. 30 pressing the sleeve of FIG. 30;

FIG. 32 is a side elevational view of the die of FIG. 31 further pressing the sleeve of FIG. 31;

FIG. 33A is a front plan view of multiple grooves of a multiple stepped die groove in accordance with another aspect of the disclosure;

FIG. 33B is a front plan view of multiple grooves of the multiple stepped die groove;

FIG. 33C is a front plan view of a groove of a multiple stepped die groove;

FIG. 34 is a side elevational view of the groove of a multiple stepped die groove of FIG. 33C in accordance with another aspect of the disclosure;

FIG. 35 is a side elevational view of the multiple grooves of FIG. 33B of the multiple stepped die groove;

FIG. 36 is a side elevational view of the multiple grooves of FIG. 33A of a multiple stepped die groove;

FIG. 37A illustrates a top plan view of a grooved tool used for a progressive pressing technique;

FIG. 37B is a perspective view of the tool of FIG. 37A;

FIG. 38 illustrates a perspective view of a roller crimping technique;

FIG. 38A is an enlarged view of detail A of FIG. 38; and

FIG. 39 illustrates a perspective view of a sleeve utilizing a marking system to identify the type of cable used therewith.

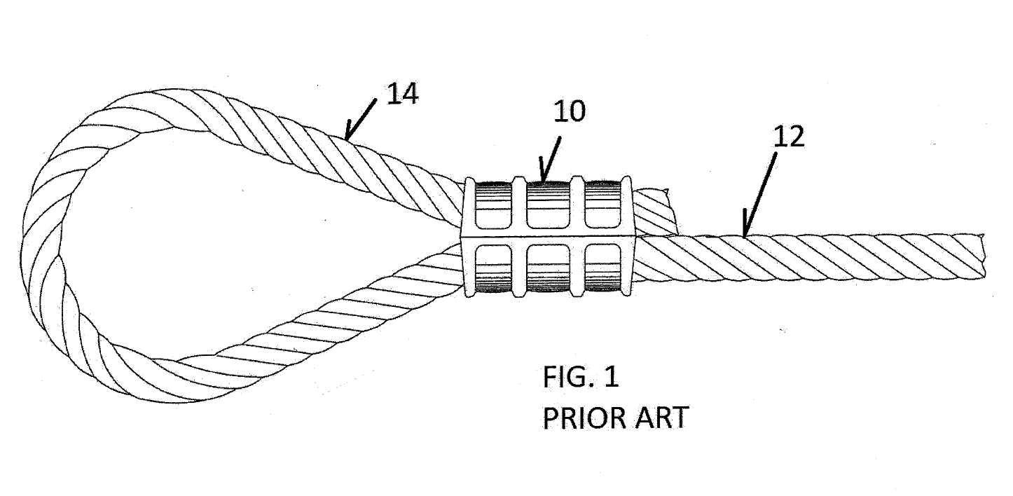

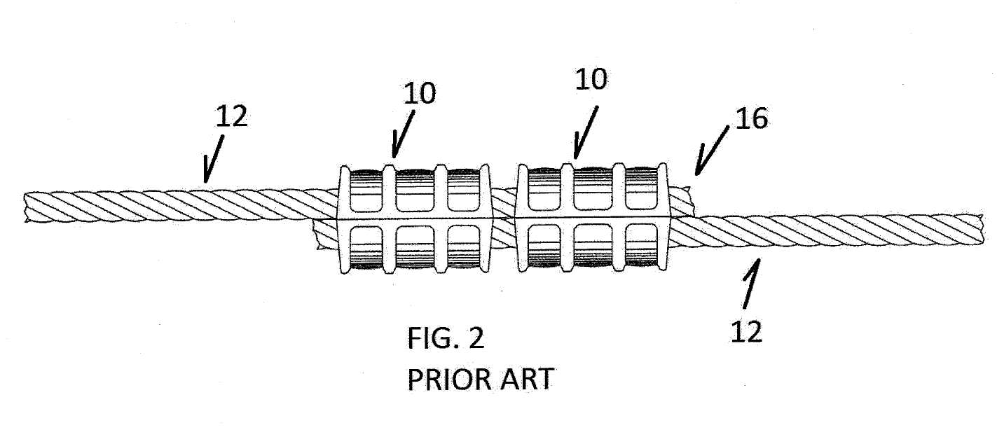

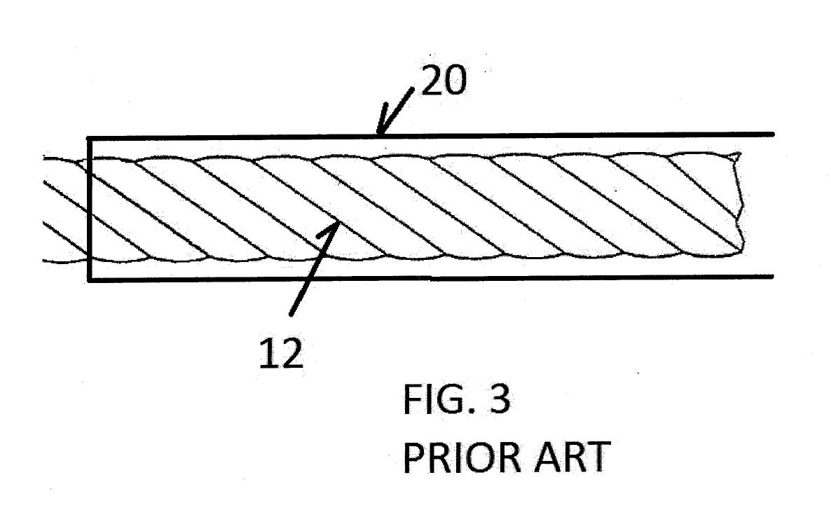

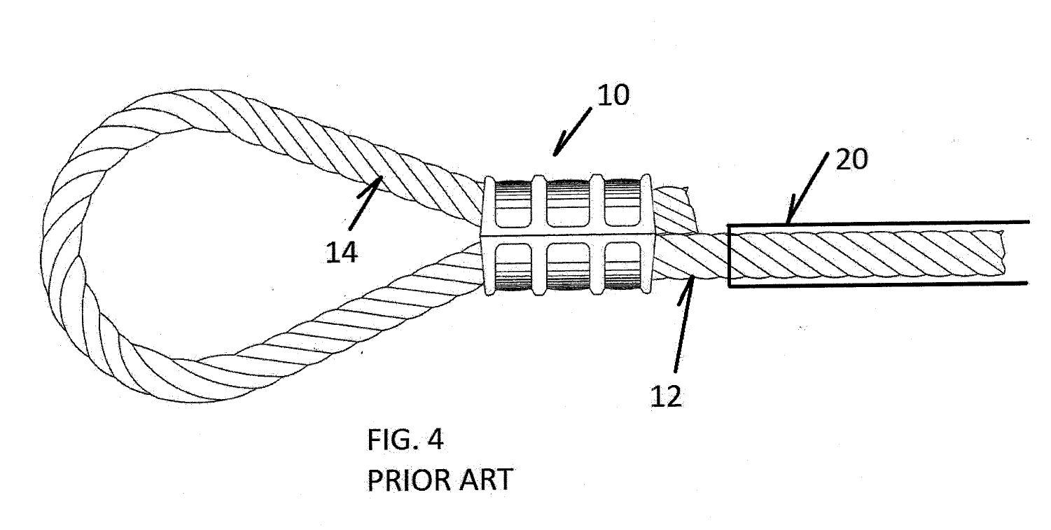

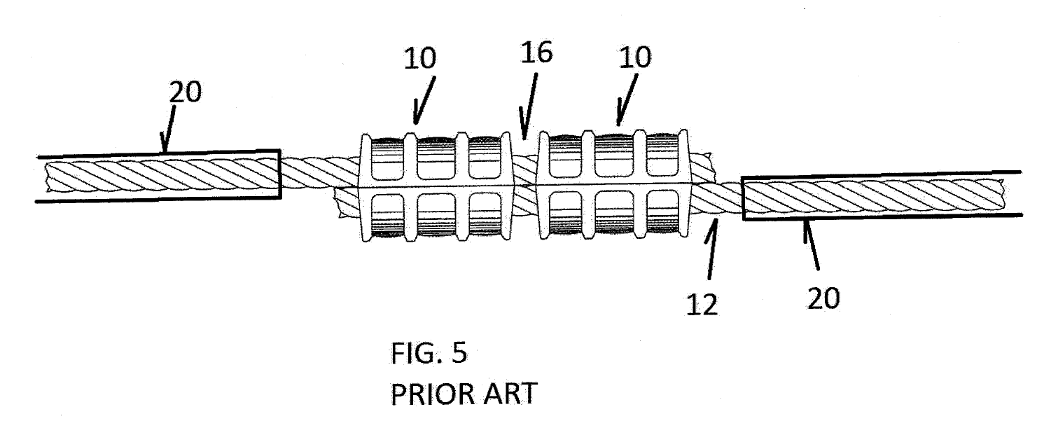

### DETAILED DESCRIPTION OF THE DISCLOSURE

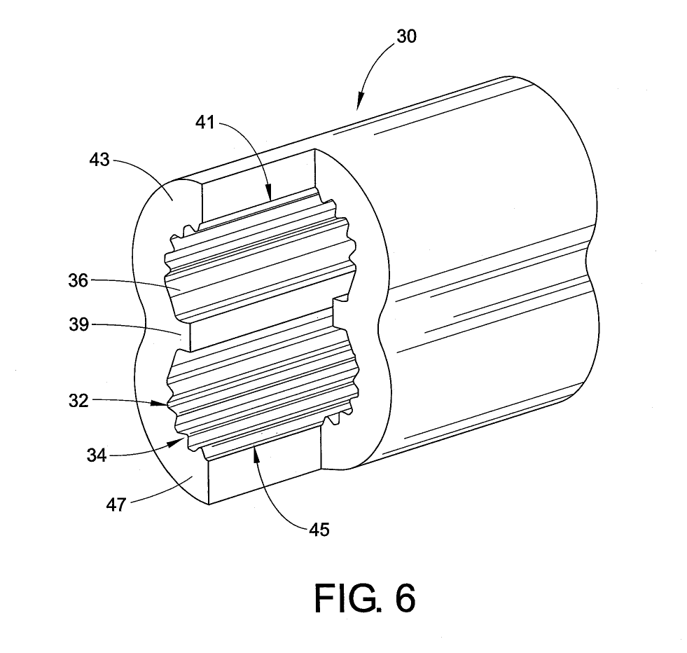

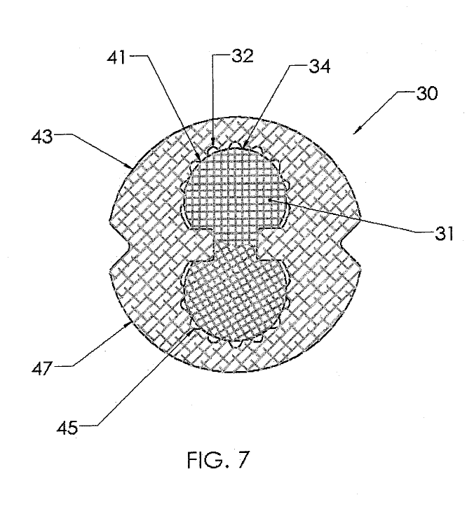

Sharp Tooth or Serrated Sleeves/Connectors (FIGS. 6, 7)

In accordance with one aspect of the disclosure, referring now to FIGS. 6 and 7, a sleeve/connector 30 has a series of blunt roots 32 with sharp (angular) tips or teeth 34 formed between the roots 32 which eliminates the need to remove the sheath by piercing the sheath. That is, the teeth and blunt roots have a configuration which removes most of the sheath from between sleeve and metal of cable 31, thereby swaging the metal sleeve to metal of the cable (i.e., metal to metal) and immobilizing any sheath remaining inside the sleeve by forming a sheath/grit matrix formed by a grit coating 36. The grit coating is applied over the roots 32 and teeth 34. The grit coating is shown in the preferred embodiment; however the grit coating is not required for the sleeve/connector to perform its function.

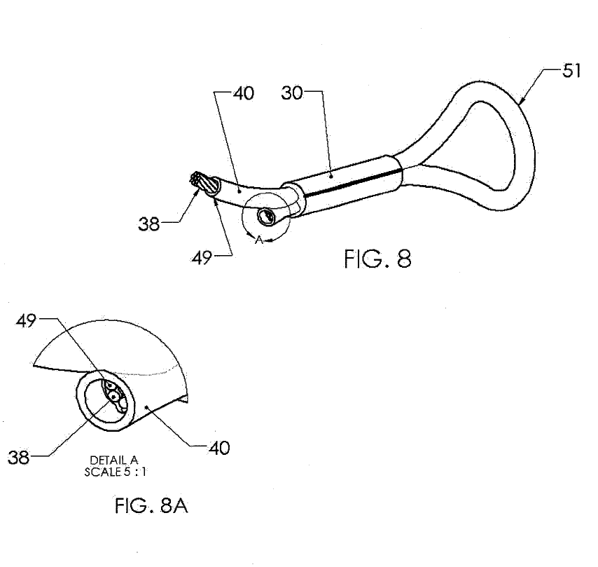

The sleeve is shown to be symmetrical such as having the appearance of a FIG. 8, where a landing or neck portion 39 is formed between upper opening 41 of upper portion 43 and a lower opening 45 formed in lower portion 47. Other configurations of sleeves are also contemplated by the disclosure.

FIG. 8 and Oval Sleeves for Insulated Cable or Wire (FIGS. 8-18)

Referring now to FIGS. 8 and 8A, another aspect of the disclosure is an end 38 of metal cable 49 is inside extruded sheath 40 of the cable eliminating the danger of cable strand ends extending out of the sheath. That is, the cable end 49 is completely enclosed within sheath 40. The cable is shown to be connected in an eye splice configuration 51.

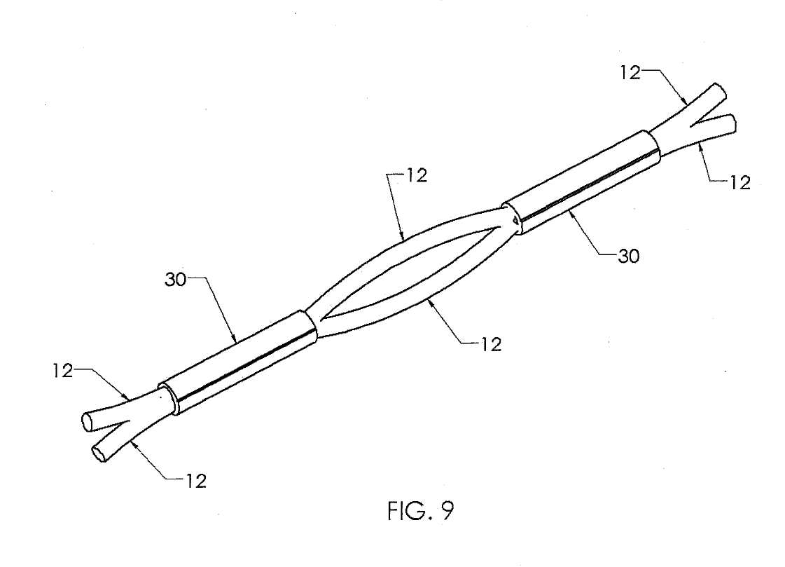

Referring to FIG. 9, yet another aspect of the disclosure is any number of sleeves/connectors 30 may be placed anywhere on an insulated cable or wire 12 to connect, tie, hold and position another cable or wire alongside another cable or wire 12.

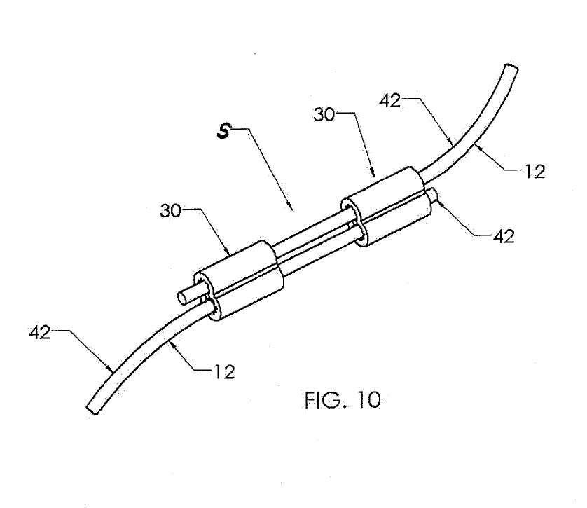

In accordance with still another aspect of the disclosure referring to FIG. 10, a lap or overlap splice 42 is used wherein two sleeves 30 may be required to break cable or wire 12 as is often the case with ordinary ovals and bare cable or wire. The spaces S between sleeves should preferably be at least a sleeve length. One sleeve should be completely pressed before starting to press the other. The spacing and pressing sequence enables relatively free extrusion of the sheath.

In accordance with another aspect of the disclosure, oval and FIG. 8 sleeves are sometimes used by electric utilities to lap splice conductors. The sleeves described herein (with or without adhesive and grit) may be used in this way on insulated conductors.

Pressing the sleeve cuts through and extrudes the cable's sheath from the press area, then swages the sleeve to the metal of the cable. After cutting through the cable's sheath, sleeve teeth or tips deform around and into the cable or wire (i.e., metal to metal contact).

Pressing also produces heat. For example, fast pressing produces a temperature rise of the sleeve and the insulation during a press, thus aiding “plastic” extrusion and removal of the sheath from the sleeve/cable interface.

An aspect of the disclosure is that the sleeve/connector eliminates the need to remove the sheath anywhere by piercing the sheath, by extruding most of the sheath from between sleeve and conductor, swaging the sleeve to the conductor (metal to metal) and immobilizing any sheath remaining inside the sleeve by forming a sheath and grit matrix; thereby making the splice, mechanically and electrically comparable to the conductor.

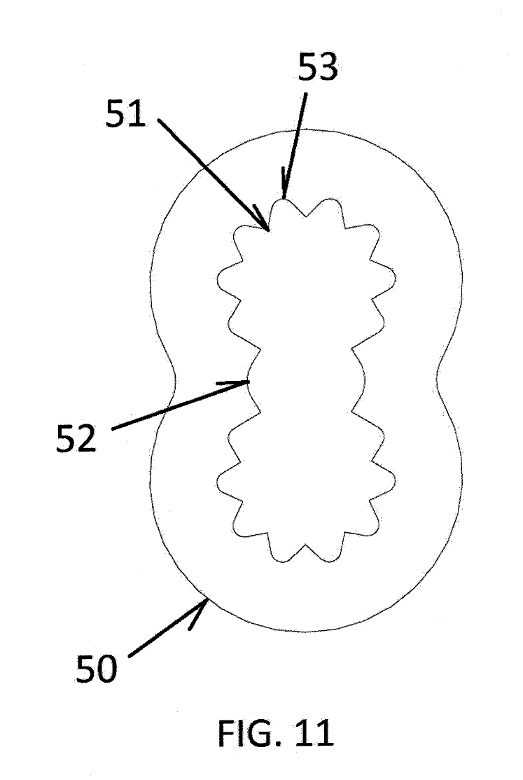

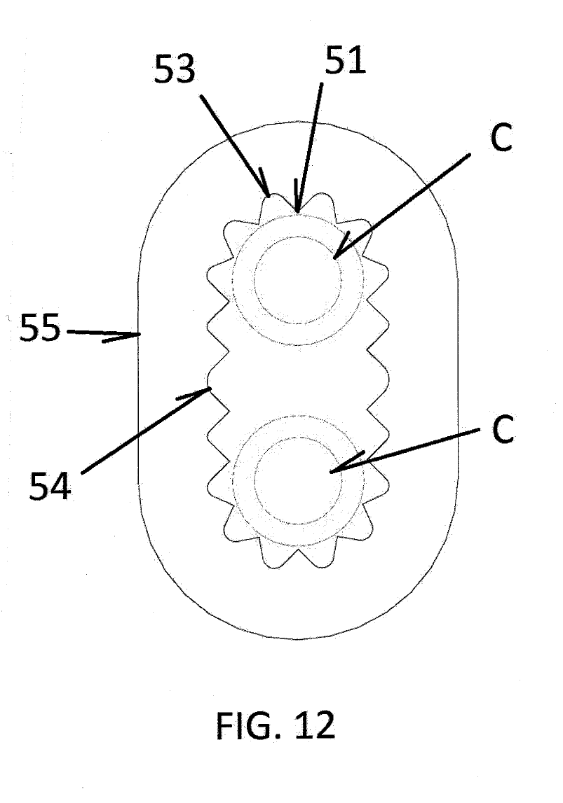

Referring now to FIG. 11, a FIG. 8 shaped sleeve 50 has an oval shaped neck 52 which is generally the most efficient method of terminating cable or wire in an eye while keeping a uniform wall thickness in the sleeve (except for the teeth). Sharp teeth 51 are formed between blunt roots 53. Referring to FIG. 12, oval shaped sleeve 55 has flat sides 54 (i.e., virtually no neck) formed between teeth 51 and blunt roots 53 and would be harder to press and provide less control of wire-teeth positioning.

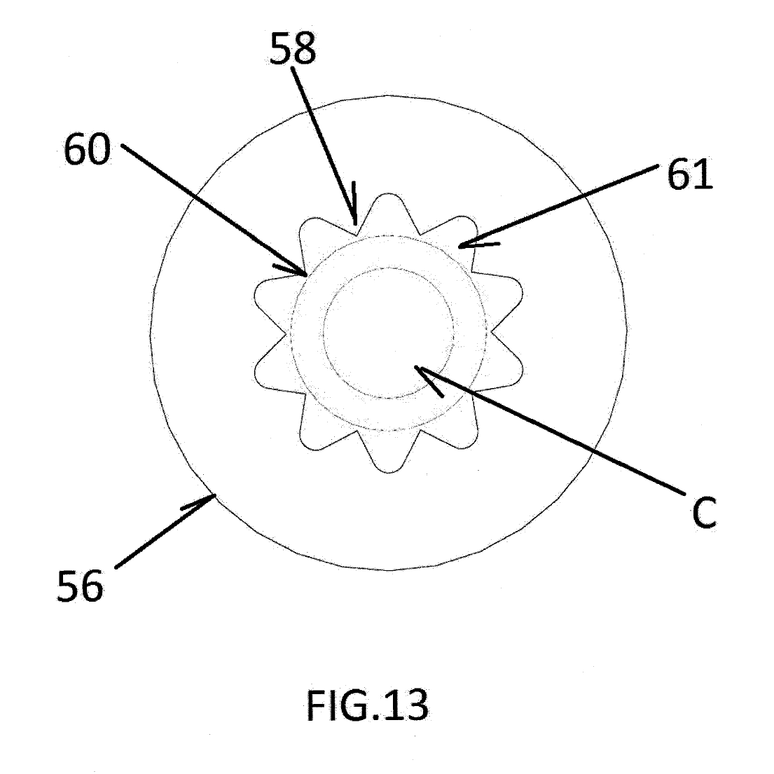

Referring to FIG. 13, a sleeve in accordance with another aspect of the disclosure is shown. A cross-section of a stop or terminating or butt splice 56 or offset dead-end sleeve or eye type dead-end with or without feedthrough is shown. Preferably, teeth 58 line the bore spaced relatively uniformly around an opening 61 with inwardly directed cutting tips 60 generally directed radially toward cable C, and the two innermost teeth on each side have a common face plane with the tooth tips diverging.

The configurations shown in FIGS. 11, 12, 13 maximize rigidity between the opposing teeth and eliminate gaps between the opposing teeth which results in a sleeve which is easier to make via extrusion or other processes.

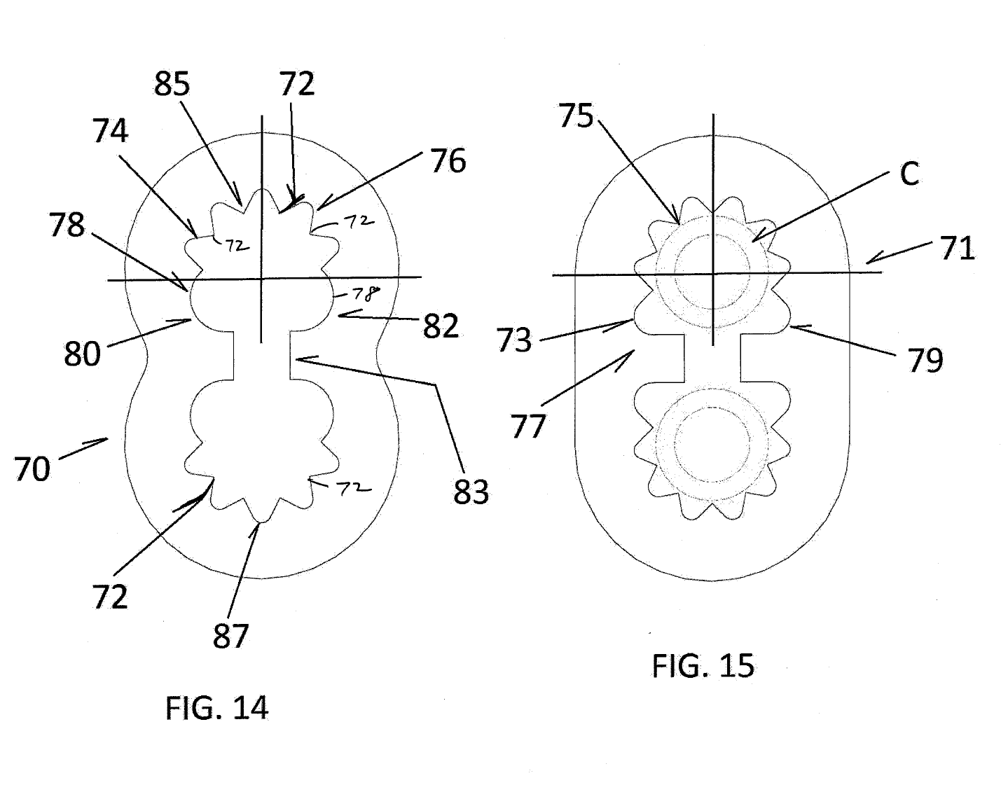

Other configurations shown in FIGS. 14 and 15 reduce the initial empty space between cable and sleeve so that the pressed sleeve contacts the metal of the cable as much as possible. The arrangements in FIGS. 14 and 15 also provide teeth 72 generally directed radially toward the cable configuration C since in an oval or FIG. 8 sleeve, teeth uniformly placed around the sleeve inner surface tend to diverge from the cable(s) in the neck area (i.e., the mid-section between the lapping cables). The arrangements in FIGS. 14 and 15 also result in surface area in the sleeve interior (i.e., between the cables) being reduced, thus improving extrusion of insulation from between the cables (using the theory of the shortest distance between two points is a straight line).

Referring specifically to FIG. 14, a preferred embodiment of this type of sleeve/connector 70 limits teeth 72 to other quadrants such as the upper quadrants 74, 76 while providing a smooth inner rounded surface 78 in lower quadrants 80, 82 to provide that the sleeve contacts as much of the cable as possible. Straight neck portion 83 separates upper and lower openings 85, 87 (opening 87 is symmetrical to opening 85) of the connector. That is, connector 70 provides space for all cables within normal tolerance variations and enable optimum tooth positioning during initial penetration of the insulating sheath.

Referring now to FIG. 15, sleeve 71 has a flat sided oval 73 formed in lower quadrants 77, 79 with an interior configuration where the teeth have the bore spaced relatively uniformly with inwardly directed cutting tips 75 (in upper quadrants), generally directed radially toward the cable, and the two innermost teeth on each side have a common face plane with the tooth tips diverging.

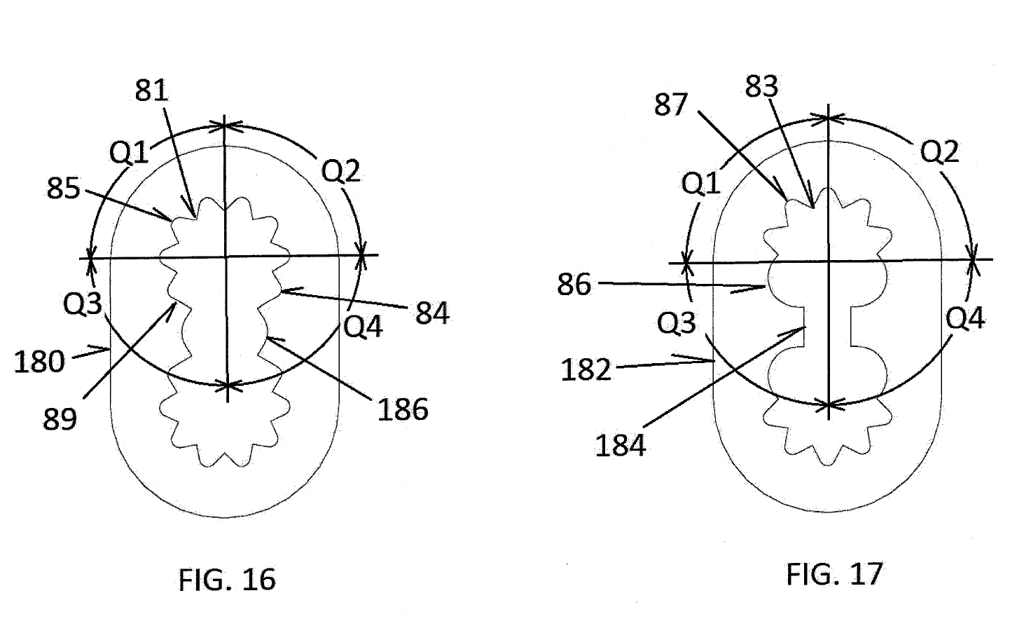

Referring now to FIGS. 16 and 17, in accordance with still another aspect of the disclosure, alternative sleeves 180, 182 have teeth 81, 83 formed between blunt roots 85, 87 in two upper quadrants Q1, Q2. In lower quadrants Q3, Q4, two flat side walls 89 are formed in sleeve 180 while oval shaped walls 86 are formed in sleeve 182.

The reason for this “special” teeth arrangement (walls 89, 86) at the neck 184 or oval 186 of the FIG. 8 sleeve 182, 180 is when a cylindrical sleeve is pressed by cylindrical opposing dies, portions of the sleeve between the dies (rather than in the dies) tend to collapse and distort first.

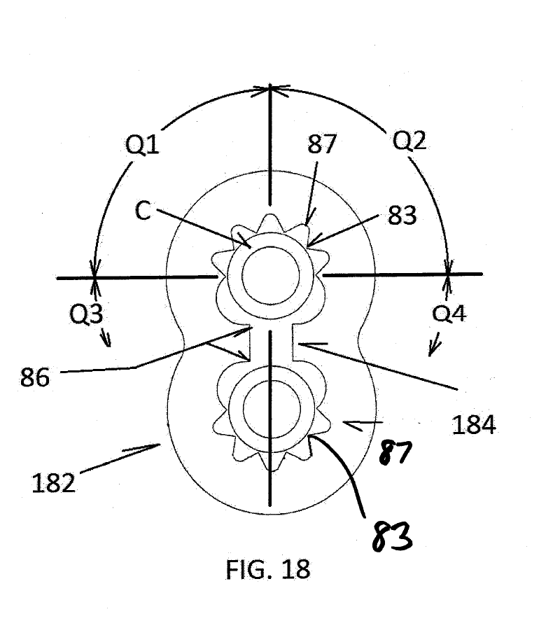

Referring now to FIG. 18, except for the four special teeth 86 in the oval or FIG. 8 sleeve's mid-section or neck 184, ideally all other teeth 83 in the other quadrants provide additional clearance for normal variations in cable/sheath outer diameter and enable optimum tooth positioning during initial penetration of the insulation. Initial collapse of the sleeve when pressed in generally cylindrical dies is in the region between the four special teeth and the teeth in those other quadrants.

This special teeth feature is not available in circularly symmetrical cross-section stops, butt splices, eye type deadends and offset splicing/dead-ending sleeves unless they deviate from circular symmetry in the crimpable portions. If circular symmetry is maintained, additional clearance between teeth tips and nominal insulation outer diameter will be required to accommodate normal cable dimensional variations. On the other hand, if nearly circularly symmetrical cross-section sleeves are marked for pressing in a particular direction, then the teeth initially between the dies might be given special treatment.

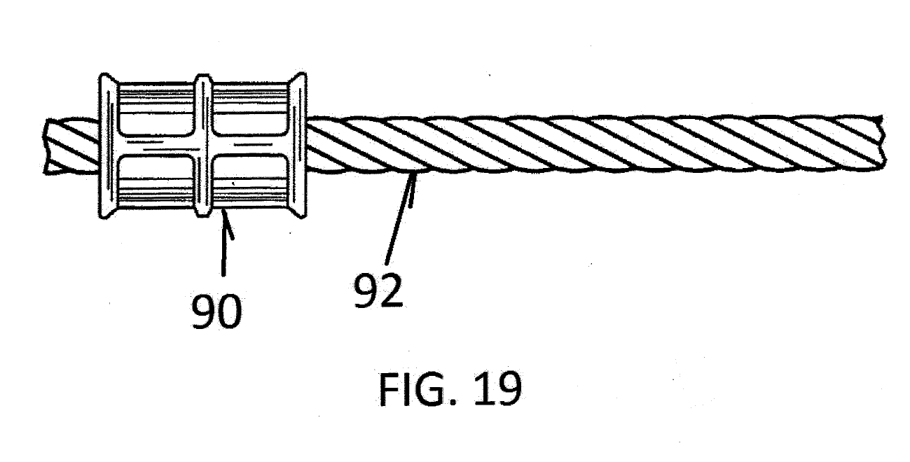

Stop or Terminating Sleeves (FIGS. 19-22)

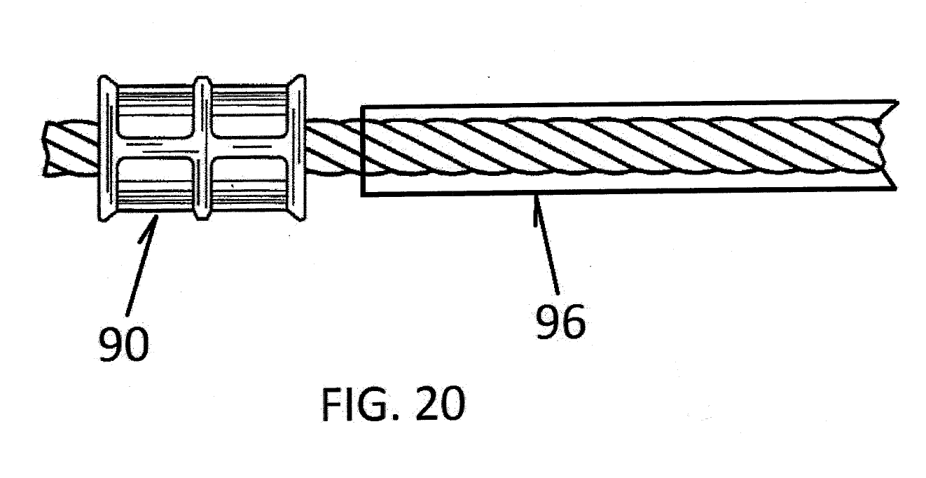

Referring to FIG. 19, in accordance with another aspect of the disclosure, cylindrical (i.e., circular) compression stop sleeves 90 are typically used to terminate wire rope 92 by providing an obstruction which stops the cable from freely passing through a hole or slot in another member. For various reasons the cable is sometimes coated with a plastic insulating sheath 96 typically fabricated of vinyl or Nylon. (see FIG. 20).

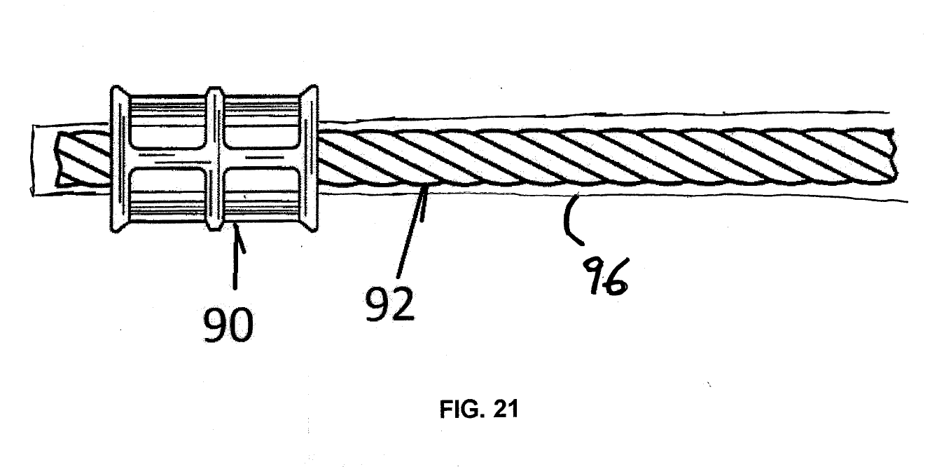

Since compression sleeves 90 do not grip plastic in a permanent manner (due to plastic creep/flow) it is necessary to remove the sheath 96 for the length of cable that passes thru the sleeve to form a stop. (see FIG. 21). The typically used process of removing the sheath 96 (i.e., by cutting, skiving, heating/melting/decomposing, dissolving, freezing/breaking, etc.) is usually time consuming, expensive, inconvenient and exposes the bare metal of the cable.

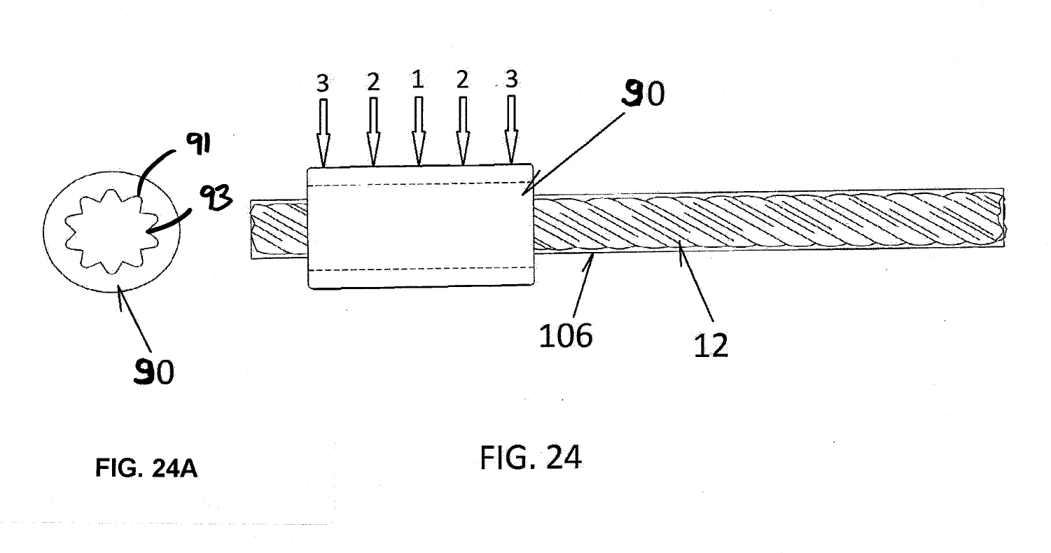

In contrast, the stop sleeve 90 of the disclosure eliminates the need to remove the plastic sheath 96 by piercing the sheath. Instead, sleeve 90 uses blunt roots 91 and sharp tips or teeth 93 (see FIGS. 24 and 24A) by extruding most of the sheath from between sleeve and metal of the cable, swaging the sleeve to metal of the cable (metal to metal) and immobilizing any sheath remaining inside the sleeve by forming a sheath/grit matrix.

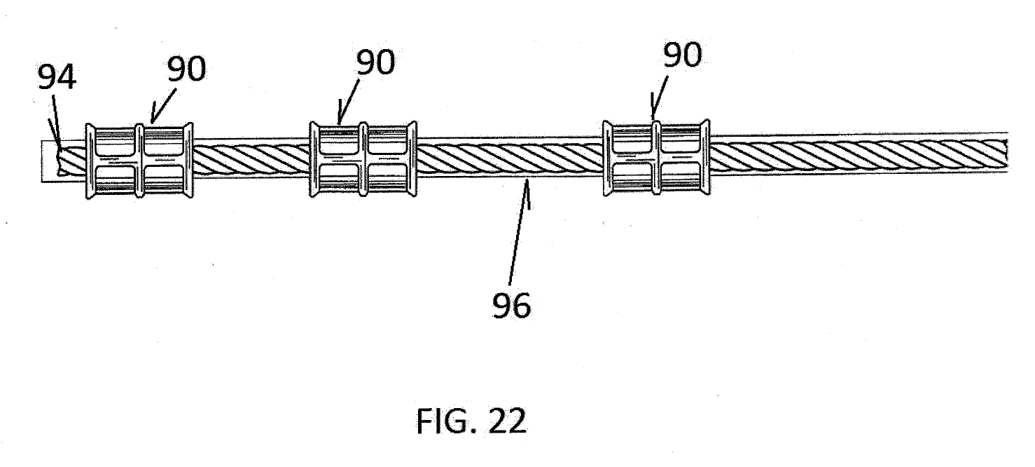

A further aspect of the stop sleeve is that metal cable end 94 is recessed inside the extruded sheath 96 eliminating the danger of cable strand ends. (see FIG. 22).

Referring still to FIG. 22, a further aspect of the disclosure is any number of stop sleeves 90 may be placed anywhere on a plastic coated cable 96 to position and hold other members along that cable.

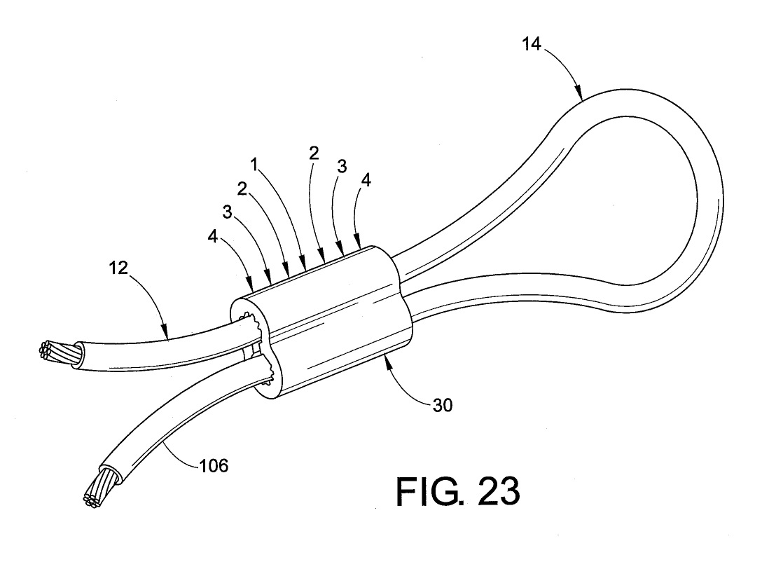

Progressive Pressing Techniques (FIGS. 23-36)

Another aspect of the disclosure is that progressive pressing can be used to crimp the sleeve, starting at the center of the sleeve which produces optimal results, that is, it enables the short initial sleeve length to hold the insulated cable in an eye splice until the cable breaks.

Progressive pressing the sleeve cuts through and extrudes sheath 106 of the cable 12 sheath from the press area by engaging teeth of the sleeve into the sheath of the cable, then swages the metal sleeve to the metal of the cable. After cutting through the cable's sheath, sleeve tooth tips deform around and into the cable or wire (i.e., metal to metal contact).

Pressing also produces heat. For example, fast pressing produces a temperature rise of the sleeve and the insulation during a press, thus aiding “plastic” extrusion and removal of the sheath from the sleeve/cable interface.

Progressive pressing, starting at the center of the FIG. 8 sleeve 30 or stop sleeve 90 (that is, starting at central position 1 and sequentially moving laterally outwardly to positions 2 and 3 and 4 on opposite sides of center position 1 produces optimum results. (see FIGS. 23, 24, and 24A).

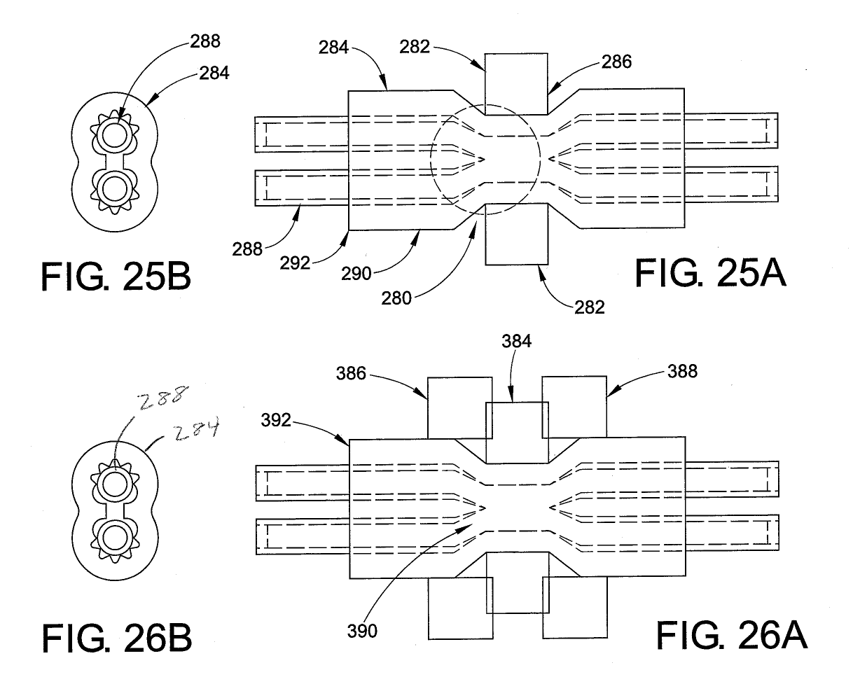

One aspect of progressive pressing is the scissors action 280 (FIGS. 25A and 25B) of dies 282 of progressive pressing which helps to extrude the insulation out of the sleeve bore. Dies 282 are positioned on opposite sides of sleeve 284 which has an indented centered portion 286 through which cables 288 are fed. The sleeves 284 are pressed by inward movement of the dies 282 toward the center of sleeve 284. The pressing action typically starts at the center of the sleeves in centered zone 286 and moves laterally or longitudinally outwardly in stages or steps toward outer zones 290, 292.

Referring to FIGS. 26A and 26B, progressive overlapping presses 384, 386, 388 can be used with standard compression tools and dies to extrude as much insulation as possible, starting at the center 390 of sleeve 392 or sleeve section in the case of offset sleeves. In the case of butt-slice sleeves and some eye type dead-ends, the press starts near the side of the center of constriction.

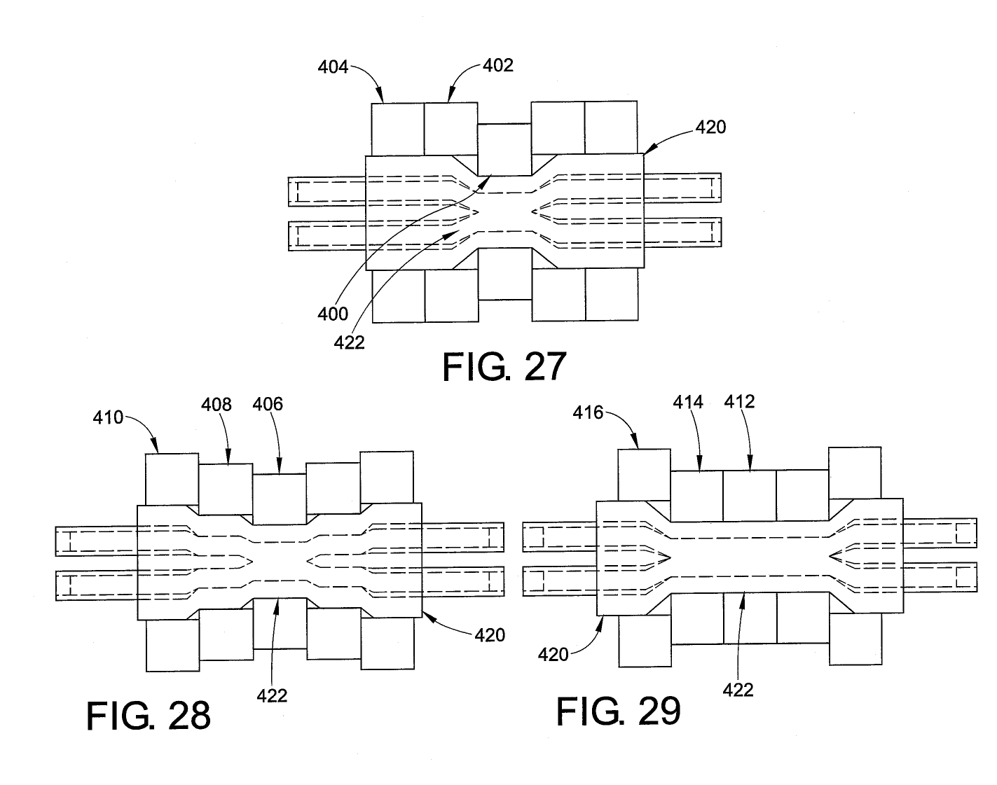

Alternatively, referring to FIGS. 27, 28, 29 the progressive press can use a single stroke with special power or punch press dies 400, 402, 404 or with spring loaded or cam driven face sections 406, 408, 410 to progressively contact the sleeve 420 and press from center outward.

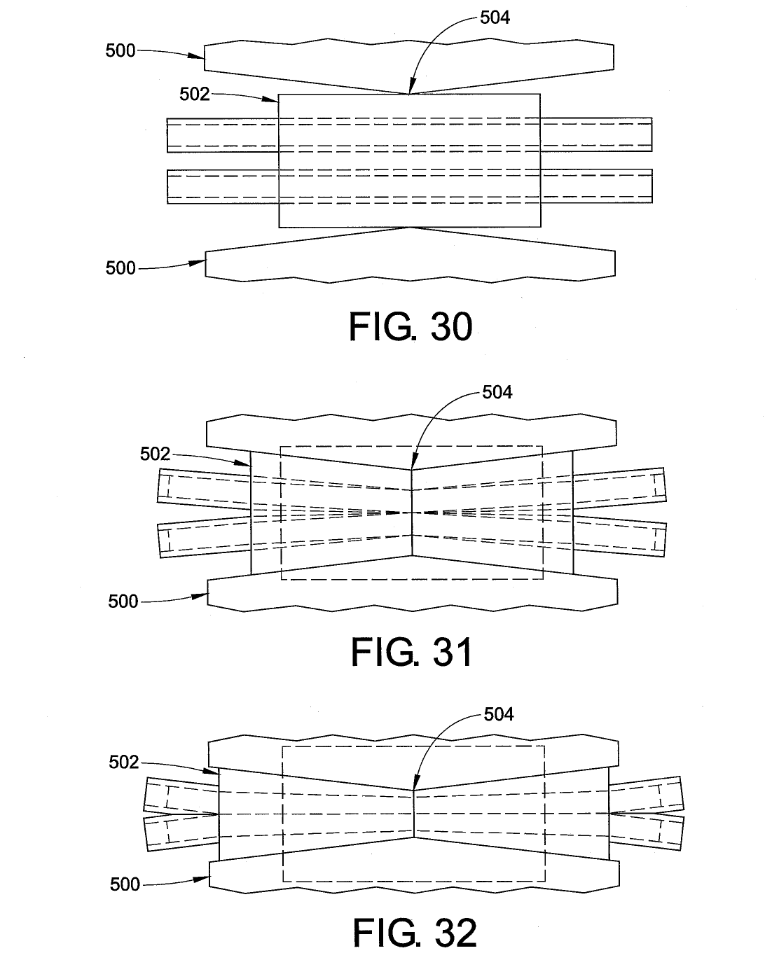

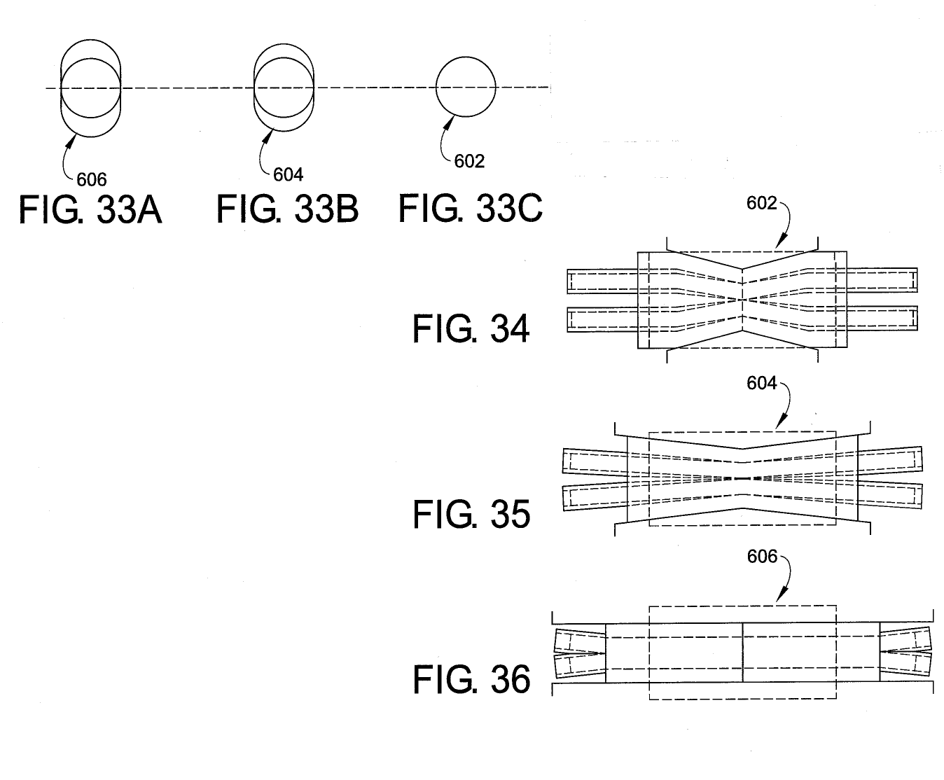

Alternatively, generally V-shaped pressing dies 500 (i.e., having zero width faces, and infinite steps) can be used for continuous progressive overlap pressing of a sleeve 502. (see FIGS. 30-32). Preferably, a single hit punch press produces a pressed sleeve with a generally narrow V-shaped press diameter locus 504. Multiple hits or presses with progressively shallower or wider generally V-shaped dies can make the finished press diameter more uniform along the sleeve length. However, uniformity of the press diameter is not required for desired performance of FIG. 8, oval and stop sleeves. Referring to FIGS. 33A, 33B, 33C, 34, 35, and 36, multiple stepped die grooves 600 having multiple grooves 602, 604, 606 in standard multi-groove tools with or without inserts such as a progressive stamping die approach solves alignment problems encountered when making adjacent overlap presses with standard tools and standard grooves.

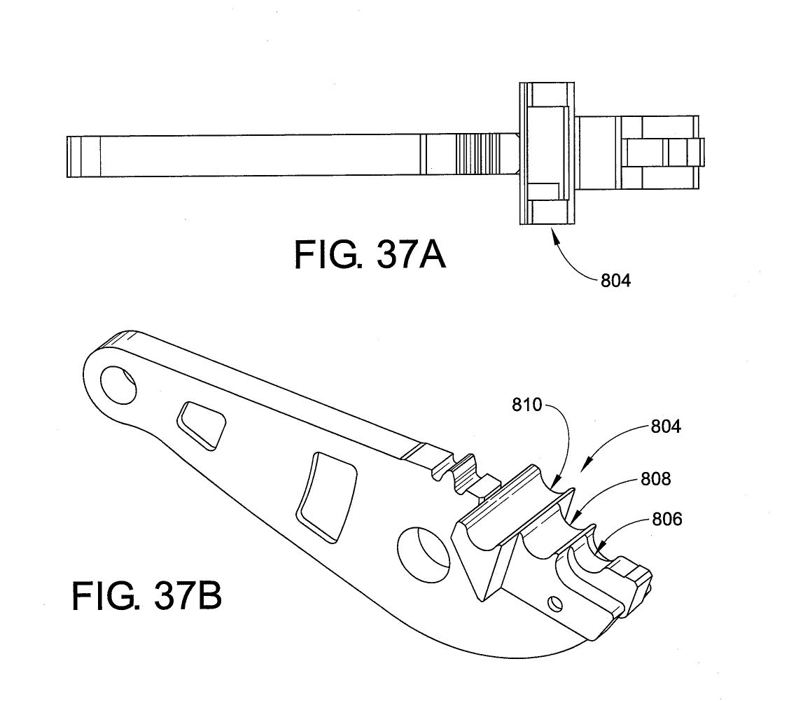

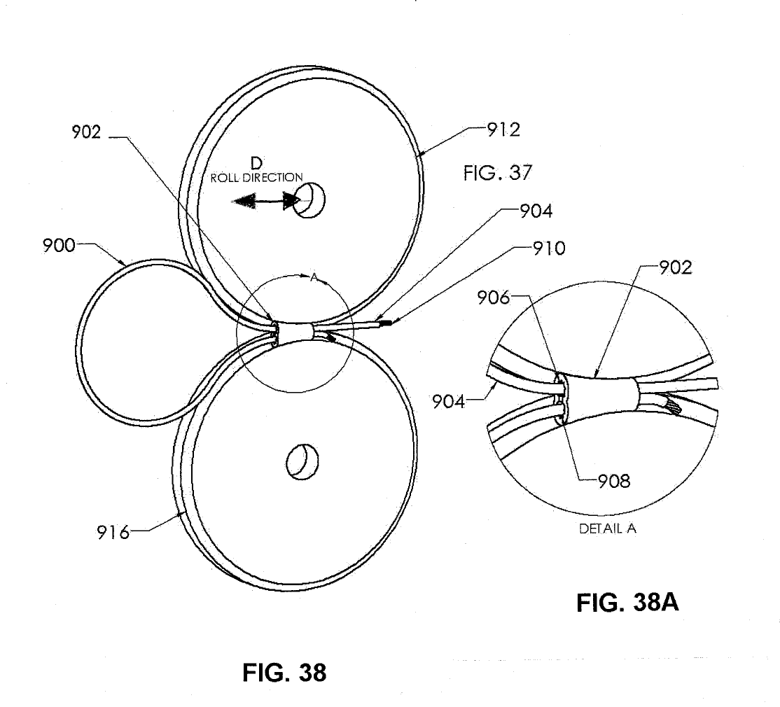

Referring to FIGS. 37A and 37B, a multiple stepped die groove tool 804 which has multiple grooves 806, 808, 810 can be used for this process.

Roll Crimping Technique (FIGS. 38,38A)

In accordance with another aspect of the disclosure, a roll crimping method for serrated sleeves is shown in FIGS. 38 and 38A.

An eye splice 900 extends into opening of serrated sleeve 902. Coated cable 904 is fed through upper and lower openings 906, 908 of sleeve 902. Wire rope or cable 910 is exposed through one end of the sleeve.

A roller crimp assembly 912 has upper and lower roller crimps 914, 916 which are positioned above and below sleeve 902 and roll in direction D in a counterclockwise manner thereby crimping the sleeve 902 onto cable 904. Direction D can be in a first direction moving from the eye splice toward the sleeve and in a second direction moving from the sleeve toward the eye splice.

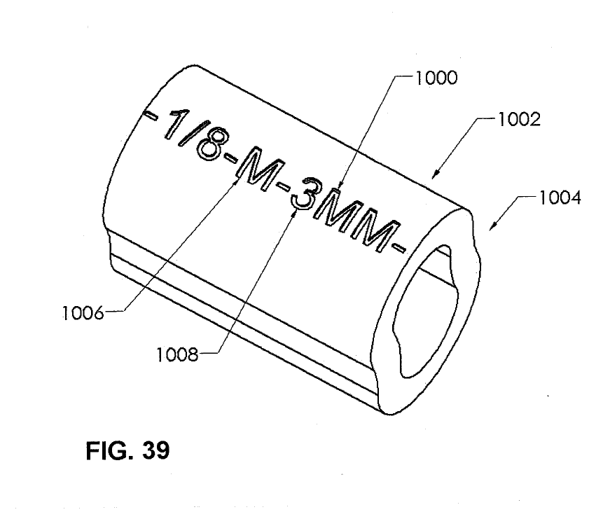

Sleeve Marking Technique (FIG. 39)

In accordance with another aspect of the disclosure, a method of marking an outer portion of a sleeve is shown in FIG. 39.

A series of indicia or markings 1000 are stamped, etched, or otherwise placed or imprinted onto outer wall 1002 of a sleeve 1004. The markings 1000 can be a series or combinations of letters 1006 or numbers 1008 which indicate the type, size, or material of cable or wire housed within the sleeve. For example, ⅛ can indicate the diameter of the wire, and the letter M can be used to designate the type of die used or material or wire. The indicia can also be used to indicate a press order for a sleeve or a die positioning for the sleeve.

Various combinations of numbers and letters can be used in various sequences as needed so that the user immediately knows by looking at the identifier that the specific sleeve is used with a specific cable or wire rope.

Aspects/Advantages of the Disclosure

One aspect of the disclosure is an oval or FIG. 8 sleeve for eye or lap splicing insulated metal cable or wire, with longitudinal or nearly longitudinal teeth grooves lining the sleeve bore, wherein the teeth are softer than the metal of the cable but hard enough to cut or puncture the insulation of the cable without significant tooth deformation until the tooth contacts the metal of the cable or wire; wherein the sleeve is compressed into and around the metal of the cable.

In accordance with another aspect of the disclosure, the teeth line the bore spaced relatively uniformly with inwardly directed cutting tips, generally directed radially toward the cable.

In accordance with another aspect of the disclosure, teeth line the bore spaced relatively uniformly with inwardly directed cutting tips, generally directed radially toward the cable, wherein the two innermost teeth on each side have a common face plane with the tooth tips diverging.

In accordance with still another aspect of the disclosure, the teeth optimally have 90° between the opposite faces of any tooth, i.e., the faces are orthogonal, wherein −90°±20° is a practical range.

In accordance with still another aspect of the disclosure, the teeth cutting tips are as sharp as possible, i.e., the tip radius is much less than the tooth height. The roots are blunt to avoid stress raisers and facilitate the flow of extruding insulation. The root shape is approximately sinusoidal between adjacent teeth faces.

In accordance with another aspect of the disclosure, the teeth are at least as high as the nominal insulation thickness, wherein average insulation thickness is usually greater than the nominal. Local insulation thickness may increase as teeth are inserted. For example, tooth height is typically 110% to 130% of nominal insulation thickness.

In accordance with still another aspect of the disclosure, the teeth are as numerous as possible; determined by tooth height, tip face angles, tip positioning to initially clear the cable insulation and the desirability to minimize empty space between sleeve and insulated cable or wire.

In accordance with still another aspect of the disclosure, the interior surfaces of the sleeve may be adhesively coated with grit and/or the space between the teeth may be filled with grit so as to convert any insulation remaining in the sleeve bore into a high viscosity matrix.

In accordance with yet another aspect of the disclosure, a stop or terminating sleeve acts as a stop on insulated metal cable or wire, with longitudinal or nearly longitudinal teeth grooves lining the sleeve bore.

The exemplary embodiment has been described with reference to the preferred embodiments. Obviously, modifications and alterations will occur to others upon reading and understanding the preceding detailed description. It is intended that the exemplary embodiment and appended claims be construed as including all such modifications and alterations insofar as they come within the scope thereof.

1. A compression sleeve for connecting cable comprises:
an outer housing having a first passage therethrough for holding a cable having a sheath thereon;
wherein said first passage comprises a series of teeth separated by blunt roots which removes said sheath from said cable thereby swaging said sleeve to a metal portion of said cable.

2. The sleeve of claim 1, wherein a grit coating is formed on said teeth and blunt root portions.

3. The sleeve of claim 1, wherein a second passage is formed in said sleeve, said second passage comprises a series of teeth between blunt root portions.

4. The sleeve of claim 3, wherein said sleeve has a substantially FIG. 8 conformation.

5. The sleeve of claim 4, wherein a neck portion is formed between said first passage of said second passage.

6. The sleeve of claim 5, wherein said first passage retains a first cable and said second passage retains a second cable in a lap splice conformation.

7. The sleeve of claim 5, wherein said first passage and said second passage retain a cable in an eye splice conformation.

8. The sleeve of claim 5, wherein said neck is substantially oval shaped.

9. The sleeve of claim 1, wherein said teeth and blunt first roots are formed in first and second quadrants of said first passage and rounded edges are formed in third and fourth quadrants of said first passage.

10. The sleeve of claim 1, wherein said teeth and blunt roots are formed in first and second quadrants of said first passage and oval portions each with a flat edge are formed in third and fourth quadrants of said first passage.

11. The sleeve of claim 1, wherein teeth and blunt root portions are formed in first and second quadrants of said first passage and oval shaped portions are formed in third and fourth quadrants of said first passage.

12. The sleeve of claim 1, wherein said outer housing of said sleeve comprises a series of indicia for indicating at least one of the following:
a type of cable to be connected by said sleeve;
a press order; and
a die positioning.

13. A method of progressively pressing a sleeve to a cable, comprising:
providing a sleeve having a plurality of teeth extending into a passage formed in said sleeve;
extending a metal cable having a sheath thereon through said passage of a sleeve;
pressing the sleeve at a first central position such that said teeth engage said sheath of said cable;
pressing the sleeve at subsequent positions extending outwardly from said center portions of said sleeve such that said teeth engage said sheath of said cable;
extruding said sheath from said cable and swaging said sleeve to said cable.

14. The method of claim 13, further comprising:
providing a first die to press on said sleeve at said first central position.

15. The method of claim 14, further comprising:
providing second and third dies to press said sleeve in second and third positions respectively outwardly of said first central position.

16. The method of claim 13, further comprising:
providing a substantially V-shaped die for extruding said sheath from said cable.

17. The method of claim 16, comprising:
providing substantially V-shaped dies successively along a longitudinal axis of said sleeve such that a narrow V-shaped die is centrally located and subsequent wide V-shaped dies are located outwardly from said narrow V-shaped extruding said sheath from said cable via multiple presses.

18. A method of roller crimping a serrated sleeve for connecting a cable, comprising:
extending a cable having a coating thereon into at least one opening of said serrated sleeve;
providing a first roller and a second roller on opposed sides of said serrated sleeve;
rolling said first roller and said second roller in one of a first rolling direction and a second rolling direction thereby crimping said serrated sleeve onto said coated cable.

19. The method of claim 18, further comprising extruding said coating from said cable.

20. The method of claim 19, wherein said coated cable forms an eye splice conformation.

21. The method of claim 20, wherein said first rolling direction is moving from said eye splice toward said sleeve and said second rolling direction is moving from said sleeve toward said eye splice.
